(19) United States
(12) Patent Application Publication
(10) Pub. No.: US 2022/0036505 A1
(43) Pub. Date: Feb. 3, 2022

(54) IN-FOCUS VISION SCREEN

(71) Applicant: Linda F. Wright-Sanders, Lakewood, CA (US)

(72) Inventor: Linda F. Wright-Sanders, Lakewood, CA (US)

(21) Appl. No.: 17/384,648

(22) Filed: Jul. 23, 2021

Related U.S. Application Data
(60) Provisional application No. 63/103,324, filed on Jul. 31, 2020.

(51) Int. Cl. G06T 3/40; G06F 3/14

(52) U.S. Cl. CPC G06T 3/40; H04M 1/724; G06F 3/14

(57) ABSTRACT

The present disclosure relates to a vision screen to be used with an electronic device, such as a smartphone, wherein the vision screen will autofocus the electronic device screen for an individual user when the user inputs the user's eye prescription into a vision screen application installed on such electronic device before using the disclosed screen.

### CROSS-REFERENCES TO RELATED APPLICATIONS

This application claims priority to Provisional Application No. 63/103,324, entitled “In-Focus Mobile Vision Screen-Mobile phones, ipads, laptops, which include all mobile devices such as iPhone, iPad, Androids and all mobile or cell phone devices. Get your full or reading prescription on your mobile device screen. No more looking for your eyeglasses or eyewear”, filed on Jul. 31, 2020, which are incorporated herein by reference in their entirety.

### FIELD OF INVENTION

The present invention relates to a vision screen to be used with an electronic device. More specifically, the present invention relates to an autofocus vision screen for an electronic device changing the screen's resolution as per an individual's prescription for eye glasses.

### BACKGROUND

Hand-held electronic devices such as laptops, tablets, smartphones, or computers display text, icons, or other features in a small font size, making it uneasy or difficult for an individual with prescription glasses to read or interact with such electronic devices.

An individual using prescription glasses has to keep the vision glasses upon themselves all the time otherwise, they constantly zoom in/zoom out the screen of the electronic device, turning the whole experience as uncomfortable and, at times, annoying.

There is a need for a screen that can autofocus the contents of the electronic device at an individual's comfort level.

### BRIEF DESCRIPTION OF THE DRAWINGS

The accompanying figures, where like reference numerals refer to steps of the process and embodiments, together with the detailed description below, are incorporated in and form part of the specification and serve to illustrate further embodiments of concepts that include the claimed disclosure and explain various principles and advantages of those embodiments.

The process and composition disclosed herein have been represented where appropriate by conventional symbols in the flowcharts, photographs, or figures, showing only those specific details that are pertinent to understanding the embodiments of the present disclosure so as not to obscure the disclosure with details that will be readily apparent to those of ordinary skill in the art having the benefit of the description herein.

FIG. 1 shows a vision screen for a device, such as a smartphone.

FIG. 2 shows a smart phone displaying a text message on screen.

FIG. 3 shows a smartphone displaying a text message with an enlarged font size as seen through the disclosed vision screen.

The exemplary embodiments described and illustrated herein should be applicable to use of vision screen on any electronic device.

### DETAILED DESCRIPTION

While the presently disclosed process and composition are susceptible of embodiment in many different forms, there is shown in the figures and will herein be described in detail several specific embodiments with the understanding that the present disclosure is to be considered as an exemplification of the principles of the present technology and is not intended to limit the technology to the embodiments illustrated.

Individuals using prescription glasses or visual aids usually find it hard to use electronic devices if they do not have their prescription glasses or visual aid with them. The text or font size is small, and if an individual user is missing prescription glasses, they are practically unable to interact with such devices. These touchscreen-oriented devices display text commands, icons, images as interactive features, where a user has to interact to make these features work for them.

An individual has to always wear prescription glasses, keep them with themselves, or have them handy in order to use these electronic devices. Sometimes even with prescription glasses or visual aids, it is difficult to interact or use these electronic devices due to the small size of its features and font.

The present invention provides a solution in the form of a vision screen which can be placed, fixed, or put on an electronic device, such as a smartphone, wherein the screen automatically focuses the viewing screen as per a user's eye prescription such that the user does not have to carry or use the prescription glasses or visual aid to interact with the electronic device.

In various embodiments, the present invention further provides a vision screen system, wherein the system comprises a communication unit comprising a vision screen application and an output unit comprising a vision screen, wherein the vision screen autofocuses the screen as per a user's prescription.

In many embodiments, the communication unit comprises a vision screen application which runs on an electronic device, such as a smartphone or other mobile devices, wherein an individual user can input personal prescription information for a left eye and/or a right eye into the application which then communicates with hardware of the electronic device and output unit to display the contents on the electronic device screen as per the user's prescription.

In various embodiments, the communication unit may communicate with a camera embedded within the electronic device to automatically adjust the resolution of the vision screen such that the device screen display images, icons, text or other features of the device at a resolution as per an individual's prescription for eye glasses.

Therefore, in various embodiments, the present invention discloses a vision screen system comprising a communication unit wherein the communication unit further comprises a vision screen application to input information regarding a user's prescription for eye glasses and an output unit, wherein the output unit display contents on the screen of the electronic device at a resolution according to user's prescription.

In various embodiments, the application as disclosed may be a mobile application, wherein the user may download the application on an electronic device. The mobile application may include an input form wherein the user may input information regarding his/her eye prescription for either the left eye, the right eye, or both the left eye and the right eye, information regarding a lens use, information about a medical condition, name, age, logbook, contact details to message directly to another user of the mobile application, record changes in prescription, and other such related information.

In various embodiments, the vision screen automatically adjusts the resolution of the electronic device screen such that the contents on the screen are displayed as per a user's eye glasses prescription as provided through the application thus obviating the need to use prescription glasses or visual aid.

In various embodiments, the disclosed invention comprises a vision screen wherein the screen communicates with the hardware of an electronic device and displays the contents of the electronic device at a resolution making communication easy and comfortable for the user.

In many embodiments, the vision screen is a screen manufactured separately as per the size of the electronic device and installed on the electronic device before its use. A user may install the vision screen by placing the screen on top of the electronic device's face area, fixing the screen on the electronic device's face area, or other means by which the vision screen becomes part of the electronic device's face area. Face area is the area of an electronic device displaying contents, icons and text on the electronic device.

In various embodiments, the disclosed vision screen comprises at least four sides bordered by curved edges. The curved edges aids in displaying contents as per individual's eye prescription. The curved edges of the vision screen make the vision screen work as though an individual is using a prescription glass placed on the electronic device.

In various other embodiments, the output unit is a vision screen of the size of the electronic device of choice. The screen can be customized as per the electronic device, such as, but not limited to, a screen customized for a mobile phone, a tablet, or a computer. The vision screen may be sized to at least substantially cover the face of the electronic device that includes the display. The length and width of the vision screen may be substantially commensurate with the length and width of the electronic device. Further, in various embodiments, the vision screen may be composed of a transparent material or a material used for preparing prescription glasses, for example, but not limited to, zylonite, acetate, and/or cellulose acetate. Further, the vision screen may include electrical properties such that the controls of the touch screen of the electronic device are usable through the vision screen.

In various embodiments, the disclosed vision screen adjusts the resolution of the screen such that a user, when interacting with the electronic device screen, see the contents on the electronic device screen as per an individual's eye prescription via the use of the vision screen. In various other embodiments, the output unit may work both as a vision screen and a screen protector. For the vision screen to function as a screen protector, it may be sufficiently thick, for example, approximately a millimeter or more, such that it is substantially rigid.

In various embodiments, a method of using a vision screen system is disclosed, comprising installing a vision screen on an electronic device; downloading a vision screen application on an electronic device; opening the vision screen application on the electronic device; entering prescription information for a user's comprising user' information for a left eye, a right eye, or both the left eye and the right eye into the vision screen application; saving the prescription information by placing identifiers, such as profile name, medical record number, or other identifying information; selecting prescription for the user; and using the electronic device, such that contents on a vision screen of the electronic device will be at a resolution according the user's prescription.

A method of using a vision screen system by more than one user, comprising: installing a vision screen on an electronic device; downloading a vision screen application on the electronic device; opening the vision screen application on the electronic device; entering prescription information for a first user, comprising prescription information for the first user's left eye, right eye, or both the left eye and the right eye into the vision screen application; entering prescription information for a second user comprising, prescription information for the second user's left eye, a right eye, or both the left eye and the right eye into the vision screen application; saving the prescription information by placing an identifier, wherein the identified for the first user will be different from the identifier for the second user; selecting prescription information for the first user if the first user uses the electronic device or selecting prescription information for the second user if the second user uses the electronic device; and using the electronic device, such that contents on a vision screen of the electronic device will be at a resolution according to either the first user's prescription information or the second user's prescription information.

In many embodiments, the disclosed vision screen system can be used by more than one individual. Further, the electronic device is used by either the first user or the second user at one time.

In many other embodiments, the disclosed vision screen application can store eye prescription information for more than one user. The user may store individual's information by creating an individual profile within the application.

When using the application (app), an individual user may enter a personal prescription for your left and right eye. After entering the personal prescription, the individual may click on it from a drop-down window, and the individual's vision will be in focus.

The In-Focus Mobile Vision Screen and Application will come to life when using an API or plug-in to input your personal prescription.

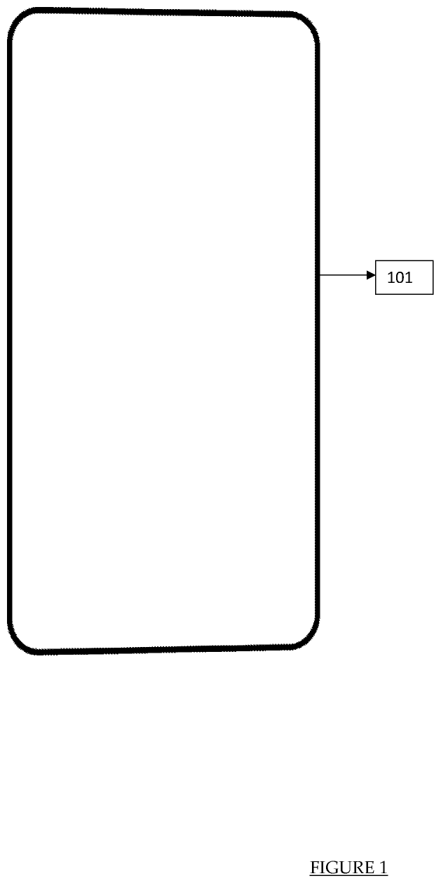

FIG. 1 illustrates a vision screen for a device, such as a smartphone. As shown in FIG. 1, a vision screen can be customized as per the size of the electronic device such as a smartphone (101). The vision screen may have curved from all edges or curved from corners and is the size of the smartphone.

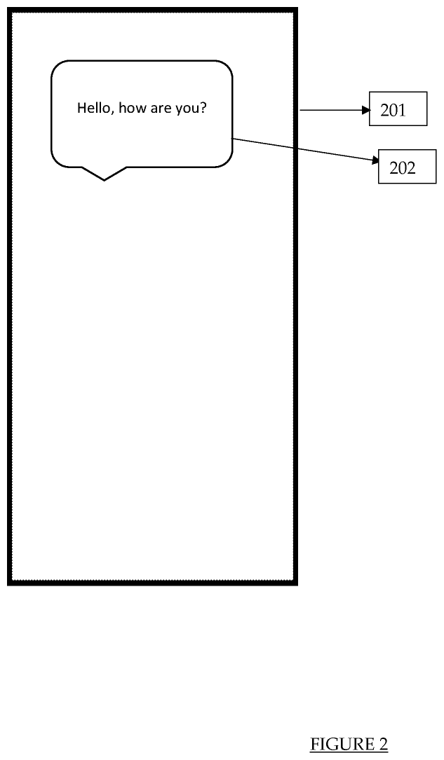

FIG. 2 illustrates a screen on a smart phone showing a text message. As shown figure shows a smart phone (201) with a text message (202) displayed on the screen.

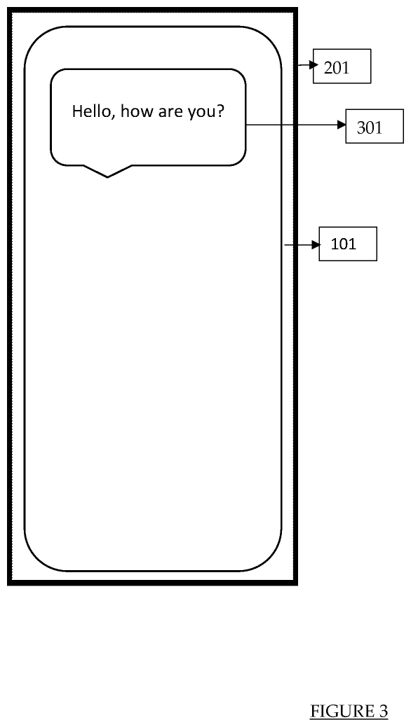

FIG. 3 illustrates a smartphone with the vision screen installed on an electronic device, such as a smartphone, showing a text message. FIG. 3 shows the smartphone (201) with the disclosed vision screen (101) placed on top of the face area of the smartphone (201) such that the vision screen is not hindering the use of smartphone or any electronic device. Once the vision screen is placed on the smart phone, a user will input prescription for eyes in the associated app, the vision screen application, and click enter. Once entered, the text, icon, image or anything that is visible on the vision screen will be shows at the resolution according to the input prescription for eyes. Here, for example, the text message (301) on the smartphone with the vision screen is enlarged as shown in FIG. 3 as compared to text message as shown in the text message on smartphone without the vision screen as in FIG. 2.

Thus, the disclosed vision screen autofocuses the contents on the electronic device screen as per individual's prescription for eye glasses.

In the description, for purposes of explanation and not limitation, specific details are set forth, such as particular embodiments, procedures, techniques, etc., to provide a thorough understanding of the present technology. However, it will be apparent to one skilled in the art that the present technology may be practiced in other embodiments that depart from these specific details.

While specific embodiments of, and examples for, the process and compositions are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not in limitation. The descriptions are not intended to limit the scope of the present technology to the particular forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A vision screen system for an electronic device, comprising:
a communication unit, wherein the communication unit comprises a vision screen application; and
an output unit, wherein the output unit comprises a vision screen, wherein the vision screen autofocuses contents on the electronic device screen as per a user's prescription for eye glasses.

2. The vision screen system of claim 1, wherein the communication unit comprises a vision screen application installed on the electronic device.

3. The vision screen system of claim 2, wherein an individual user may input personal prescription information for a left eye, a right eye, or both the left eye and the right eye into the vision screen application.

4. The vision screen system of claim 2, wherein the vision screen application communicates with the hardware of the electronic device and the output unit to display the contents on the electronic device screen as per the user's eye prescription.

5. The vision screen system of claim 1, wherein the vision screen automatically adjusts the resolution of the electronic device screen as per the user's eye prescription.

6. The vision screen system of claim 1, wherein the vision screen comprises at least four sides bordered by curved edges.

7. The vision screen system of claim 1, wherein the output unit is a vision screen of a size of the electronic device.

8. The method of claim 1, wherein the electronic device may be a smartphone.

9. The method of claim 1, wherein the vision screen is installed on the electronic device before use.

10. The vision screen system of claim 1, wherein the vision screen comprises electrical properties for touch screen use of the electronic device.

11. A method of using a vision screen system, comprising:
installing a vision screen on an electronic device;
downloading a vision screen application on the electronic device;
opening the vision screen application on the electronic device;
entering prescription information for a user, comprising prescription for the user's left eye, a right eye, or both the left eye and the right eye into the vision screen application;
saving the prescription information by placing an identifier;
selecting prescription for the user; and
using the electronic device, such that contents on an electronic device screen is displayed at a resolution according to the user's prescription for eye glasses.

12. The method of claim 11, wherein the electronic device may be a smartphone.

13. The method of claim 11, wherein the vision screen is a screen installed separately on the electronic device before use.

14. The method of claim 13, wherein the screen comprises at least four sides bordered by curved edges.

15. A method of using a vision screen system by more than one user, comprising:
installing a vision screen on an electronic device;
downloading a vision screen application on the electronic device;
opening the vision screen application on the electronic device;
entering prescription information for a first user, comprising prescription information for the first user's left eye, right eye, or both the left eye and the right eye into the vision screen application;
entering prescription information for a second user comprising, prescription information for the second user's left eye, a right eye, or both the left eye and the right eye into the vision screen application;
saving the prescription information by placing an identifier, wherein the identified for the first user will be different from the identifier for the second user;
selecting prescription information for the first user if the first user uses the electronic device or selecting prescription information for the second user if the second user uses the electronic device; and
using the electronic device, such that contents on the electronic device screen displayed at a resolution according to either the first user's prescription for eye glasses or the second user's prescription for eye glasses.

16. The method of claim 15, wherein the electronic device may be a smartphone.

17. The method of claim 15, wherein the vision screen is a screen installed separately on the electronic device before use.

18. The method of claim 17, wherein the vision screen comprises at least four sides bordered by curved edges.

19. The method of claim 15, wherein the electronic device is used by either the first user or the second user at a time.

20. The method of claim 15, wherein the vision screen automatically adjusts the resolution of the electronic device screen as per the user's eye prescription.
